(19) United States
(12) Patent Application Publication
(10) Pub. No.: US 2016/0101458 A1
(43) Pub. Date: Apr. 14, 2016

(54) PUNCHING DEVICE FOR IMPROVING SURFACE ROUGHNESS, PATTERN PROCESSING METHOD USING SAME, AND PATTERN THEREOF

(71) Applicants: Halla Visteon Climate Control Corp., Daejeon (KR); S H TECHNOLOGY CO., LTD., Hwaseong-si (KR)

(72) Inventors: Jeongho KIM, Daejeon (KR); Woojin KIM, Daejeon (KR); Youngshin KIM, Daejeon (KR); Sungtaeg OH, Daejeon (KR); Seungyong HWANG, Daejeon (KR); JangHyun KIM, Anyang-si (KR); DuHeyon CHI, Seoul (KR)

(21) Appl. No.: 14/643,094

(22) Filed: Mar. 10, 2015

(30) Foreign Application Priority Data
Oct. 8, 2014 (KR) 10-2014-0135727

(51) Int. Cl. B21D 53/10; F16K 1/42; B21D 28/10

(52) U.S. Cl. CPC B21D 53/10; B21D 28/10; F16K 1/42

(57) ABSTRACT

A punching device for forming a predetermined pattern (20) on a surface near a discharge hole (11) and an intake hole (11) of a valve plate for a compressor comprises: a seating jig (100) to which the valve plate (10) is fixed; a processing pin (200) in which a pressing part (210) for pressing the valve plate (10) is formed at a distal end thereof; and a moving unit (300) which is disposed on an upper portion of the seating jig (100), horizontally moves the processing pin (200) at a constant speed while allowing the processing pin (200) to vertically reciprocate at a constant speed, so as to form the pattern (20) on the valve plate (10).

### BACKGROUND OF THE INVENTION

1. Field of the Invention

The present invention relates to a punching device for improving surface roughness, a pattern processing method using the same, and a pattern thereof and, more particularly, to a punching device which punches a part near a discharge hole and an intake hole of a valve plate for a compressor, while a processing pin moves at a predetermined interval, to form a suitable pattern, a pattern processing method using the same, and a pattern thereof.

2. Description of the Prior Art

Generally, a piston-type compressor such as swash plate compressor, etc., has a cylinder, an intake chamber, and a discharge chamber, which are partitioned by a valve plate, and the valve plate has an intake groove formed through a part thereof in contact with the intake chamber and a discharge groove formed through a part thereof in contact with the discharge chamber.

Further, an intake valve is disposed on the surface close to the cylinder of the valve plate, and a discharge valve is disposed on the surface close to the intake chamber and the discharge chamber of the valve plate. The intake valve has an intake lead part formed at a location corresponding to the intake groove, and the discharge valve has a discharge lead part formed at a location corresponding to the discharge groove.

During the operation of such a compressor, the intake lead part of the intake valve and the discharge lead part of the discharge valve opens/closes the intake groove and the discharge groove of the valve plate according to the reciprocating of the piston. Since a lubricant component contained in a refrigerant is attached to the piston, these lead parts are in strongly close contact with the surface of the valve plate due to the surface tension.

Thus, since an instantaneous pressure change is generated when the intake groove and the discharge groove are opened/closed, abnormal noise is generated at an evaporator in contact with the compressor, or a shock sound is applied to the lead parts, thereby generating noise and vibration.

Thus, recently, a method of processing and roughening the surface of the valve plate into a predetermined pattern so as to implement silence is proposed in order to reduce noise and vibration.

Noise and vibration generated due to opening/closing of the intake valve and the discharge valve are restrained by roughening the surface of the valve plate. The shot blast scheme of injecting a shot particle such as an alumina using air pressure is mainly used as the conventional roughening.

The shot blast scheme masks the surface of the valve plate, injects a shot particle, and then washes the surface of the valve plate.

However, a cutting scrap from the surface of the valve plate which is cut by a shot particle, or the shot particle itself may remain on the surface of the valve plate as a foreign matter and, such a foreign matter is introduced into a compressor, thereby generating a poor operation or failure of the compressor.

Further, one end obtained by the surface processing is sharp and keen, and thus is easily worn, and the processed surface is more sunken than the existing surface. Accordingly, a probability to lose a pocket function of storing oil may increase.

Of course, in order to solve the problem, a pattern for roughening is formed on the surface using the press processing scheme.

Such a press processing scheme engraves a pattern for roughening on a mold, presses a valve plate using a press device, and forms a pattern for roughening in a necessary part.

However, such a press processing scheme has a probability that a surrounding part is bending-deflected by a reaction during pressing, and since types of patterns which can be formed in a mold is limited, it is difficult to implement various shapes.

Further, when a part of the pattern of the mold is damaged, the entirety of the mold should be separated and replaced. Thus, maintenance thereof is difficult.

### PRIOR ART DOCUMENT

[Patent document] Korean Patent No. 10-0536790

### SUMMARY OF THE INVENTION

In order to solve the aforementioned problem, an aspect of the present invention is to provide a punching device for improving surface roughness which performs punching in a vertical direction while horizontally moving a processing pin, and forms a pattern having a plurality of dots on the surface of an object, thereby minimizing wear resulting from friction and making maintenance easy, a pattern processing method using the same, and a pattern thereof.

In order to achieve the above-mentioned object, a punching device for improving surface roughness and forming a predetermined pattern 20 on a surface near a discharge hole 11 and an intake hole 11 of a valve plate for a compressor according to the present invention is provided. The punching device comprises: a seating jig 100 to which the valve plate 10 is fixed; a processing pin 200 in which a pressing part 210 for pressing the valve plate 10 is formed at a distal end thereof; and a moving unit 300 which is disposed on an upper portion of the seating jig 100, horizontally moves the processing pin 200 at a constant speed while allowing the processing pin 200 to vertically reciprocate at a constant speed, so as to form the pattern 20 on the valve plate 10.

The punching device further comprises: a height adjusting support 400 for adjusting a height of the moving unit 300.

The pressing part 210 has a conic shape, a diameter of which is decreased downwardly.

A slope angle a of the pressing part 210 is one of 60 degrees, 90 degrees, and 120 degrees.

The pressing part 210 has a distal end, a sectional surface of which is hexagonal or polygonal.

In order to achieve the above-mentioned object, provided is a pattern processing method for horizontally and vertically moving a processing pin 200 having a processing part formed at a distal end thereof so as to form a predetermined pattern 20 on a surface near a discharge hole 11 and an intake hole 11 of a valve plate 10 for a compressor, wherein the processing pin 200 vertically reciprocates at a constant speed while horizontally moving along an outer periphery of the discharge hole 11 and the intake hole 11 so as to perform punching, and as being farther from the discharge hole 11 and the intake hole 11, a vertical moving speed is identical and a horizontal moving speed of the processing pin 200 is identical or increased.

In order to achieve the above-mentioned object, provided is a punching pattern 20 formed on a surface near a discharge hole 11 and an intake hole 11 of a valve plate 10 of a compressor, wherein a plurality of lines L, in which a dot 12 having a predetermined shape is formed to be spaced apart from each other at a predetermined interval along an outer periphery of the discharge hole 11 and the intake hole 11, are formed to be spaced apart from each other to become father from the discharge hole 11 and the intake hole 11, and an interval between the lines L becomes larger as being farther from the discharge hole 11 and the intake hole 11.

The punching pattern 20 comprises: a first section 21 which is formed along an outer periphery of the discharge hole 11 and the intake hole 11 and does not have the line L formed therein; a second section 22 which is formed on an outer side of the first section and has the plurality of lines L formed therein; and a third section 23 which is formed on at outer side of the second section 22 and has the plurality of lines L formed therein, wherein an interval between the lines L and an interval between the dots 12 are larger than those of the second section 22.

The above-described punching device, the pattern processing method using the same, and the pattern thereof according to the present invention have the following effect.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a punching device according to an embodiment of the present invention;

FIG. 2 is an enlarged perspective view illustrating a distal end of a processing pin of a punching device according to an embodiment of the present invention;

FIG. 3 is an enlarged perspective view illustrating a distal end of a processing pin of a punching device according to another embodiment of the present invention;

FIG. 4 illustrates a planar structure of a punching device according to yet another embodiment of the present invention;

FIG. 5 is a plan view illustrating a pattern formed using a punching device according to an embodiment of the present invention;

FIG. 6 is a plan view illustrating a pattern formed using a punching device according to another embodiment of the present invention; and

FIG. 7 illustrates a sectional structure of a pattern formed using a punching device according to an embodiment of the present invention.

[Reference numerals]

| | |
|---|---|
| 100: Seating jig | 110: Fixing protrusion |
| 200: Processing pin | 210: Pressing part |
| 300: Moving unit | |
| 400: Height adjusting support | |
| 10: Valve plate | 11: Discharge hole, intake hole |
| 12: Dot | 13: Protrusion |
| 20: Pattern | 21: First section |
| 22: Second section | 23: Third section |

### DETAILED DESCRIPTION OF THE EXEMPLARY EMBODIMENTS

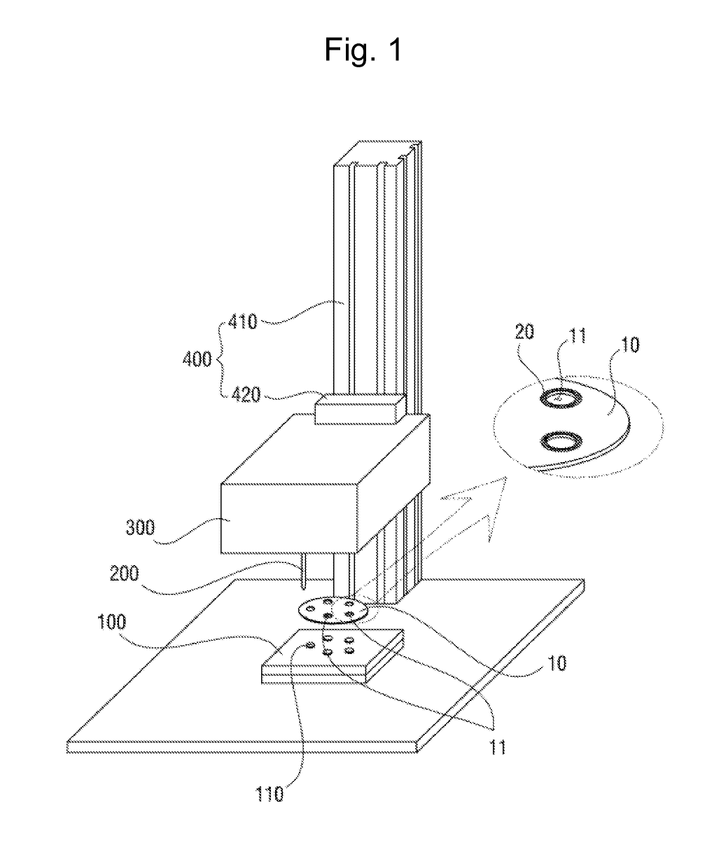

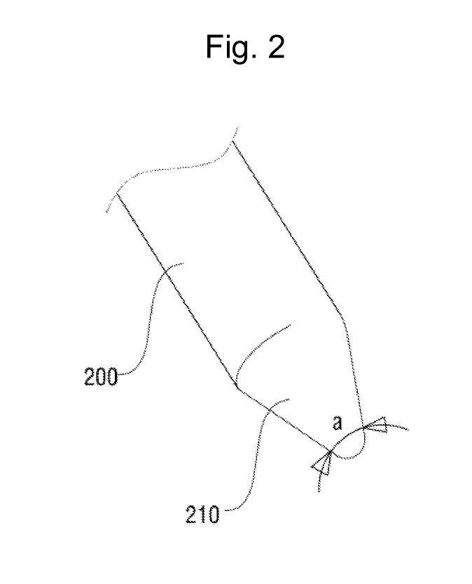

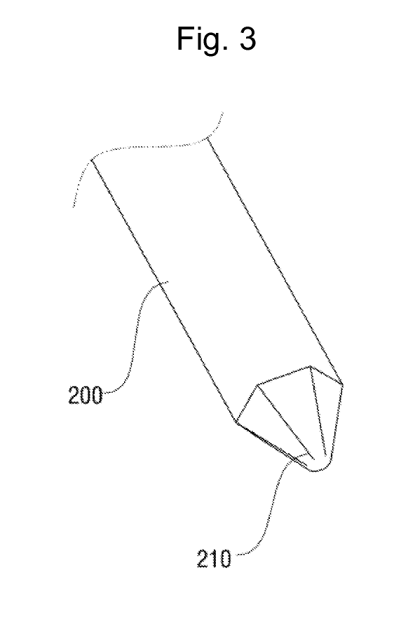

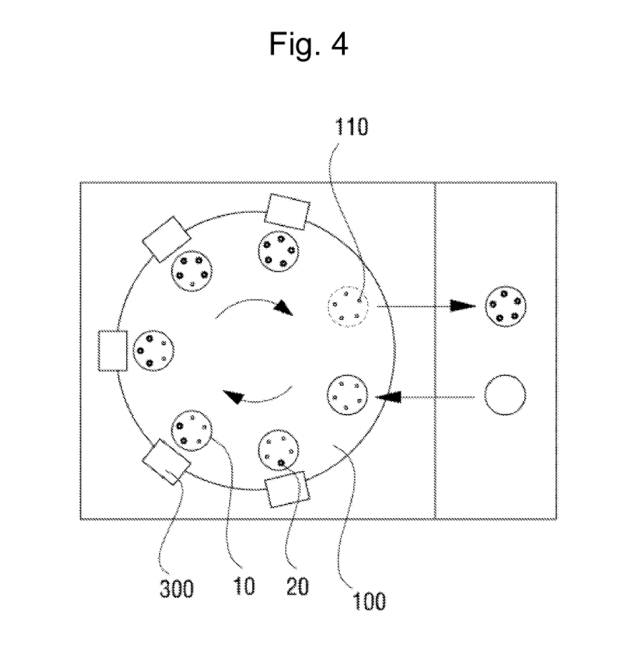

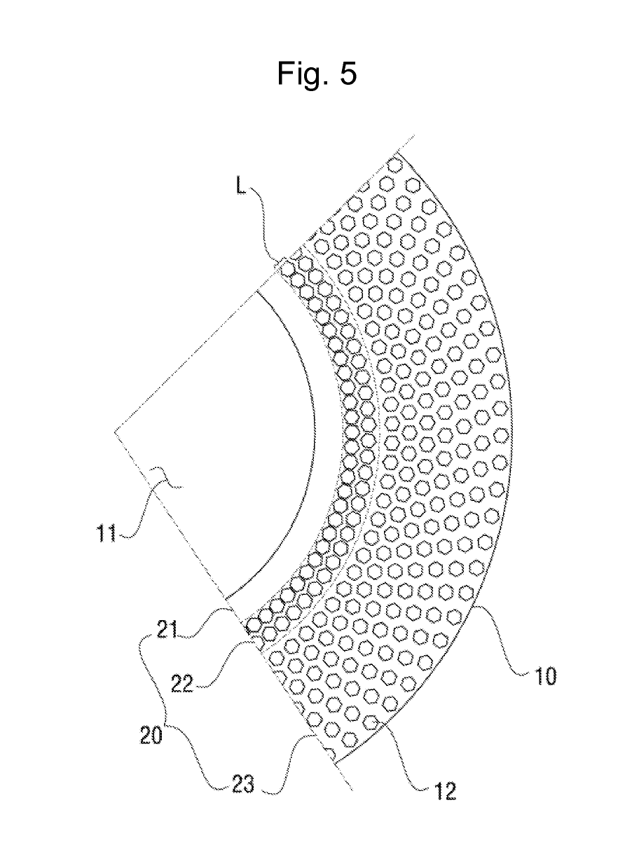

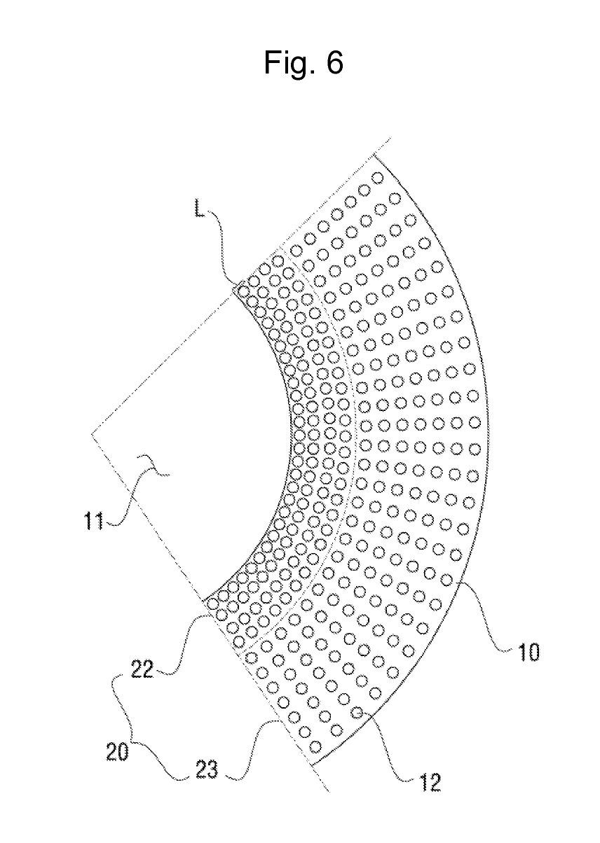

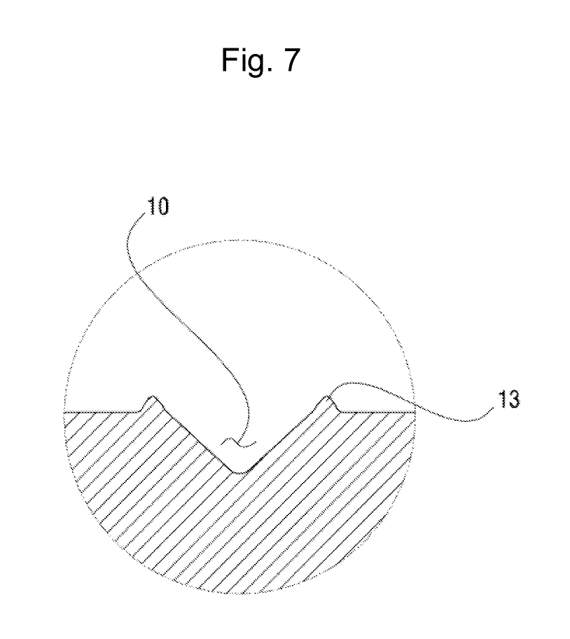

FIG. 1 is a perspective view illustrating a punching device according to an embodiment of the present invention; FIG. 2 is an enlarged perspective view illustrating a distal end of a processing pin of a punching device according to an embodiment of the present invention; FIG. 3 is an enlarged perspective view illustrating a distal end of a processing pin of a punching device according to another embodiment of the present invention; FIG. 4 illustrates a planar structure of a punching device according to yet another embodiment of the present invention; FIG. 5 is a plan view illustrating a pattern formed using a punching device according to an embodiment of the present invention; FIG. 6 is a plan view illustrating a pattern formed using a punching device according to another embodiment of the present invention; and FIG. 7 illustrates a sectional structure of a pattern formed using a punching device according to an embodiment of the present invention.

As illustrated in FIGS. 1 and 2, a punching device according to an embodiment of the present invention includes a seating jig 100, a processing pin 200, a moving unit 300, and a height adjusting support 400.

The seating jig 100 fixes a valve plate 10 which is an object to be punched and is formed in the shape of a flat plate which is parallel to the moving unit 300 which will be described below.

Here, the valve plate 10 is used for a compressor, etc., and has an intake hole 11 formed therein to be connected to an intake chamber of a cylinder and a discharge hole 11 formed therein to be connected to a discharge chamber.

A fixing protrusion 110 which is inserted into the discharge hole 11 and the intake hole 11 when the valve plate 10 is seated is formed on the upper surface of the seating jig 100.

The fixing protrusion 110 is formed at an interval identical to a distance between the discharge hole 11 and the intake hole 11, guides a location where the valve plate 10 is fixed, and prevents an arbitrarily horizontal movement after fixing.

In some cases, the seating jig 100 may have a pressing means to prevent the valve plate 10 fixed on the upper surface from being left, and a tilting means capable of adjusting a slope to process a product having a sloped surface, and a vibration prevention means for absorbing vibration to reduce noise generated during processing.

Meanwhile, the processing pin 200 has the shape of pin elongated in the vertical direction and has a pressing part 210 formed on the lower end thereof to press the valve plate 10 while moving around the discharge hole 11 and the intake hole 11 of the valve plate so as to a circular dot 12.

As illustrated in FIG. 2, the pressing part 210 has a conic shape in which the diameter of a tip end decreases toward the lower portion, the tip end being rounded.

Further, as illustrated in FIG. 2, the slope angle (a) of the side surface of the pressing part 210 is 90 degrees.

Of course, in some cases, the slope angle (a) of the pressing part 210 may be 60 degrees or 120 degrees. When the slope angle (a) is 60 degrees, the diameter of the dot 12 is small and the depth of the dot 12 is deep. When the slope angle (a) is 90 degrees, the diameter of the dot 12 is large and the depth of the dot is shallow.

Such a pressing part 210 forms the concave circular dot 12 on the valve plate 10 while downwardly moving by the moving unit 300, which will be described below, and forms a pattern 20 formed by the plurality of dots 12 while horizontally moving by the moving unit 300.

Here, the pattern 20 is filled with oil, and the oil increases the surface roughness of the valve plate 10 to decrease noise and vibration generated during friction of the valve plate 10 using the surface tension of the oil.

Meanwhile, in some cases, as illustrated in FIG. 3, the pressing part 210 may have the shape of a hexagonal pyramid.

In detail, the sectional surface of the pressing part 210 is a hexagon and is decreased toward the lower portion, wherein an end thereof is rounded.

Such a pressing part 210 having the shape of a hexagonal pyramid forms a hexagonal concave dot 12 when pressing the valve plate 10.

Here, when the shape of the dot 12 is a hexagon, the pattern 20 formed on the valve plate 10, which will be described below, can have the dots 12 as many as possible within the same area while minimizing a surplus space between the dot 12 and the dot 12.

In this way, since the pressing part 210 has the shape of a hexagon, the dots 12 are formed within the same area as many as possible, so that oil is applied to the entire area while an amount of oil filled in the dots 12 is minimized, thereby maximizing space utilization, improving the stability of the pattern 20, and minimizing the surface tension during friction with a lead.

Of course, the shape of the pressing part 210 may be a triangle, a quadrangle, a pentagon, etc. in addition to the circle or the hexagon.

Meanwhile, the moving unit 300 is disposed on the upper portion of the seating jig 100, and moves the processing pin 200 in the horizontal direction at a constant speed while the processing pin 200 reciprocates in the vertical direction at a constant speed, thereby forming a pattern 20 on the valve plate 10.

That is, the moving unit 300 allows the processing pin 200 to reciprocate in the vertical direction about 10 times per 1 second and move the processing pin 200 in the horizontal direction along a part around the discharge hole 11 and the intake hole 11 by 10 to 80 mm at each second so as to form the plurality of circular concave dots 12 near the discharge hole 11 and the intake hole 11 at a constant interval, thereby forming a pattern 20, which is like a general marking machine.

Here, the moving unit 300 is operated by a program of driving an XY axis stage step motor to move the processing pint 200 and solely processing a pattern by a CNC.

Further, the moving unit 300 can, when moving upward/downward, adjust air pressure to adjust the depth of the dot 12.

Meanwhile, the moving unit 300 can freely adjust the height by the height adjusting support 400.

The height adjusting support 400 is to adjust an interval between the seating jig 100 and the moving unit 300, is formed by a guide part 410 elongated vertically and an elevating part 420 mounted to be vertically movable along the guide part 410, and vertically moves while the moving unit 300 is mounted to the elevating part 420.

In this way, in the punching device having the aforementioned configuration according to an embodiment of the present invention, the processing pin 200 is easily mounted to and separated from the moving unit 300. Further, in the case of the conventional mold, when the mold is damaged, a problem that it is difficult to exchange the mold is improved, thereby making the maintenance easier, and the moving speed, the moving direction, the pressure, etc. can be adjusted without replacing the processing pin 200, or various dots 12 and patterns 20 can be formed by changing the shape of a processing part of the processing pin 200.

Meanwhile, in some cases, the punching device according to the present invention can be configured by an index-type automation system.

In detail, as illustrated in FIG. 4, in the index-type automation system, the seating jig 100 is formed in a circular shape and turns around on its axis, and a plurality of fixing protrusions 110 are formed on the upper surface of the seating jig 100 along the circumference to fixedly arrange 7 valve plates 10 at a constant interval.

That is, 7 sets of the fixing protrusions 110 are provided.

Further, 5 sets are provided and are arranged in the fixing protrusions side by side, respectively, each set including the moving unit 300, the processing pin 200, and the height adjusting support 400.

The moving unit 300, which constitutes 5 sets, forms the pattern 20 near one of the plurality of intake holes 11 or the plurality of discharge holes 11 formed on the valve plate 10.

That is, when 3 intake holes 11 and 2 discharge holes 11 are formed on the valve plate 10, one of the moving units 300 forms the pattern 20 near one of the intake holes 11, and another moving unit 300 neighboring it forms the pattern 20 at another intake hole 11 or another discharge hole 11 neighboring the intake hole 11.

Here, the seating jig 100 is rotated at an interval of about 51 degrees, one valve plate 10 has the pattern 20 formed near the intake hole 11 and the discharge hole 11 while passing through 5 sets of the moving units 300, and in 2 sets of the fixing protrusions 110, an operator withdraws the valve plate 10 and mounts the valve plate 10 again.

Of course, the withdrawing and the mounting of the valve plate 10 may be performed not manually but automatically using a hydraulic system, and may be performed by a system automatized in a conveyor form.

In this way, a plurality of fixing protrusions 110 are formed such that a plurality of valve plates 10 are mounted on the upper surface of the seating jig 100, and the pattern 20 is formed by the plurality of moving units 300 and the processing pin 200 while the seating jig 100 is rotated, so that the processing device is automatized, thereby performing a work a little more efficiently and thus improving a productivity.

Meanwhile, the pattern 20 formed by the processing pin 200 is formed by a plurality of lines L in which a plurality of dots 12 are formed along an outer periphery of the discharge hole 11 and the intake hole 11 while being spaced apart from each other at a predetermined interval. The lines L are arranged to be spaced apart from each other in a direction in which the lines L become farther from the discharge hole 11 or the intake hole 11, and an interval between the lines L is increased as they become farther from the discharge hole 11 and the intake hole 11.

In more detail, as illustrated in FIG. 5, the pattern 20 is formed by a first section 21, a second section 22, and a third section 23.

The first section 21 is formed along an outer periphery of the discharge hole 11 or the intake hole 11 and does not have the lines L formed therein.

That is, the first section 21, the surface of which is not processed from the outer periphery of the discharge hole 11 or the intake hole 11 in a direction in which the lines L become farther therefrom, is formed in a ring shape.

The width of the first section 21 is formed to be about 0.5 mm.

The second section 22 corresponds to an interval which is formed on an outer side of the first section 21 and has the plurality of lines L formed therein, and has a ring-shaped pattern 20 obtained by processing a plurality of dots 12 at a predetermined interval along the outer periphery of the first section 21.

Further, the width of the second section 22 is formed to be about 1.0 mm.

The second section 22 is an interval which is rubbed with the lead part of the compressor cylinder, and oil is applied thereto, thereby reducing the surface tension while the surface thereof becomes uneven by the shape of the pattern 20 and thus minimizing noise and vibration.

The third section 23 is an interval which is formed on an outer side of the second section 22 and has the plurality of lines L and in which an interval between the lines L and an interval between the dots 12 are larger than those of the second section 22.

The second section 23 is not rubbed with the lead parts, is used as an interval in which oil is filled, and has the width of about 2.1 mm.

Here, it is preferred that an interval between the lines L of the second section 22 is 0.1-0.2 mm and an interval between the lines L of the third section 23 is 0.2-0.5 mm.

Meanwhile, in some cases, the pattern 20 may be formed by only the second section 22 and the third section 23.

In this case, as illustrated in FIG. 6, the second section 22 has about 0 to 5 lines L arranged therein outwardly from the outer periphery of the discharge hole 11 or the intake hole 11, and the third section 23 has about 15 lines L arranged therein.

Of course, the number of lines L can be adjusted from 20 to 50.

In this way, the interval between the lines L is increased as they become farther from the discharge hole 11 and the intake hole 11, thereby reducing the surface tension of the second section 22 in which friction is directly generated, and thus minimizing noise and vibration and increasing a content of oil on the third section 23.

Further, as illustrated in FIG. 7, in the dots 12 constituting the line L, only a processed part thereof is formed to be concave and an unprocessed surface thereof is flat, so that the dots 12 can be not easily worn when being rubbed with the lead parts and can maintain a constant height.

Further, a protrusion 13 protruding by a reaction generated during processing is formed in the periphery of the dots 12, thereby preventing the height from being lowered due to the wear of the existing surface, and increasing the surface roughness to reduce generation of the surface tension.

Meanwhile, in a punching method for forming the pattern 20, the moving unit 300 is manipulated to perform processing while the processing pine 20 horizontally moves along the outer periphery of the discharge hole 11 and the intake hole 11 and vertically reciprocates at a constant speed.

Here, the moving units 300 have the same vertical moving speed and the processing pine 200 has an increased horizontal moving speed as they become farther from the discharge hole 11 and the intake hole 11.

That is, the moving units 300 allow the processing pin 200 to vertically reciprocate 10 times per about 1 second while the processing pin 200 horizontally moves 10-30 mm per about 1 second in the second section 2 and horizontally moves 30-80 mm per about 1 second in the third section 23.

In this way, the punching method according to an embodiment of the present invention can form various patterns 20 by speeds without replacing equipment such as the processing pin 200, thereby improving the productivity and the efficiency.

The punching device, the punching method using the same, the pattern thereof according to an embodiment of the present invention, which have the above configurations, use the moving units 300 to form the plurality of dots 12 by the processing pin 200, thereby forming the pattern 20. Further, only the surface of the valve plate 10 is processed, so that the surface is not sharpened and has a smooth curve, thereby preventing the pattern 20 from easily worn during friction with the lead parts, and the protrusion 13 is formed near the dots 12, thereby preventing the height from becoming lower than the existing surface.

In particular, the processing part has a hexagonal shape and thus the dots 12 can be formed on a constant area as many as possible so as to maximize an oil pocket function and minimize the surface tension, thereby further reducing noise and vibration.

Further, a program of the moving units 300 is manipulated, thereby forming the pattern 20 having various shapes, the processing pin 200 can be easily replaced, making the maintenance easier, and the shape of the processing part is changed so as to form the dots 12 having various shapes, thereby improving usability.

The present invention is not limited thereto and can be implemented in various modified forms by those skilled in the art without departing from the technical spirit and scope of the following claims. Accordingly, the modification should be interpreted to be within the scope of the present invention.

What is claimed is:

1. A punching device for improving surface roughness and forming a predetermined pattern (20) on a surface near a discharge hole (11) and an intake hole (11) of a valve plate for a compressor, the punching device comprising:
a seating jig (100) to which the valve plate (10) is fixed;
a processing pin (200) in which a pressing part (210) for pressing the valve plate (10) is formed at a distal end thereof; and
a moving unit (300) which is disposed on an upper portion of the seating jig (100), horizontally moves the processing pin (200) at a constant speed while allowing the processing pin (200) to vertically reciprocate at a constant speed, so as to form the pattern (20) on the valve plate (10).

2. The punching device of claim 1, further comprising: a height adjusting support (400) for adjusting a height of the moving unit (300).

3. The punching device of claim 1, wherein the pressing part (210) has a conic shape, a diameter of which is decreased downwardly.

4. The punching device of claim 1, wherein a slope angle (a) of the pressing part (210) is one of 60 degrees, 90 degrees, and 120 degrees.

5. The punching device of claim 1, wherein the pressing part (210) has a distal end, a sectional surface of which is hexagonal or polygonal.

6. A pattern processing method for horizontally and vertically moving a processing pin (200) having a processing part formed at a distal end thereof so as to form a predetermined pattern (20) on a surface near a discharge hole (11) and an intake hole (11) of a valve plate (10) for a compressor, wherein the processing pin (200) vertically reciprocates at a constant speed while horizontally moving along an outer periphery of the discharge hole (11) and the intake hole (11) so as to perform punching, and as being farther from the discharge hole (11) and the intake hole (11), a vertical moving speed is identical and a horizontal moving speed of the processing pin (200) is identical or increased.

7. A punching pattern (20) formed on a surface near a discharge hole (11) and an intake hole (11) of a valve plate (10) of a compressor, wherein a plurality of lines (L), in which a dot (12) having a predetermined shape is formed to be spaced apart from each other at a predetermined interval along an outer periphery of the discharge hole (11) and the intake hole (11), are formed to be spaced apart from each other to become father from the discharge hole (11) and the intake hole (11), and an interval between the lines (L) becomes larger as being farther from the discharge hole (11) and the intake hole (11).

8. The punching pattern (20) of claim 7, comprising:
a first section (21) which is formed along an outer periphery of the discharge hole (11) and the intake hole (11) and does not have the line (L) formed therein;
a second section (22) which is formed on an outer side of the first section and has the plurality of lines (L) formed therein; and
a third section (23) which is formed on at outer side of the second section (22) and has the plurality of lines (L) formed therein, wherein an interval between the lines (L) and an interval between the dots (12) are larger than those of the second section (22).
